(19) United States
(12) Patent Application Publication
(10) Pub. No.: US 2014/0342212 A1
(43) Pub. Date: Nov. 20, 2014

(54) CELL CONTACTING ARRANGEMENT FOR AN ENERGY STORAGE MODULE

(71) Applicants: BAYERISCHE MOTOREN WERKE AKTIENGESELLSCHAFT, Munchen (DE); DIEHL METAL APPLICATIONS GMBH, Berlin (DE)

(72) Inventors: Hubertus Goesmann, Auernheim (DE); Wolfgang Suess, Freising (DE); Harald Heck, Nurnberg (DE); Falk Linzmaier, Uhldingen-Muhlhofen (DE)

(73) Assignee: BAYERISCHE MOTOREN WERKE AKTIENGESELLSCHAFT, Munchen (DE)

(21) Appl. No.: 14/357,479

(22) PCT Filed: Nov. 23, 2012
(86) PCT No.: PCT/EP2012/004859

§ 371 Date: May 9, 2014

(30) Foreign Application Priority Data
Nov. 24, 2011 (DE) 10 2011 087 040.7

(51) Int. Cl. H01M 2/20

(52) U.S. Cl. CPC H01M 2/206; H01M 2220/20
USPC 429/121; 29/623.1

(57) ABSTRACT

The present invention relates to a cell contacting arrangement for an energy storage module having a plurality of electrochemical storage cells, each storage cell having at least two electric connection terminals, the arrangement comprising:

a carrier plate which is mountable on the energy storage module, a plurality of cell connectors which are inserted or integrated into the carrier plate for contacting the connection terminals, a cable harness for contacting the cell connectors, and a separate cable harness support which is mountable on the carrier plate for receiving the cable harness.

The present invention refers to a cell contacting arrangement for an energy storage module having a plurality of electrochemical storage cells, each storage cell having at least two electric connection terminals. Furthermore, the present invention refers to a high-voltage battery for power supply, particularly an automotive vehicle, comprising at least one energy storage module and a cell contacting arrangement. Moreover, the present invention refers to a method for producing the cell contacting arrangement.

In a high-voltage storage device, which is normally called battery, for the power supply of an automotive vehicle, energy storage modules are used for driving the vehicle, e.g. electric vehicles or hybrid vehicles. A respective energy storage module typically consists of a plurality of stacked storage cells. The individual storage cells contain electrochemical cells of the battery. The stack consisting of the individual storage cells is mostly clamped. Apart from the mechanical fixation of the modules relative to one another, clamping particularly serves to counteract deformation by gas pressure changes which during operation occur in the electrochemical cells arranged in the interior of the modules. The plurality of storage cells of the energy storage modules must be electrically interconnected.

It is the object of the present invention to indicate a cell contacting arrangement for an energy storage module which, while being producible and mountable at low costs, has a flexible modular structure. Moreover, it is the object of the present invention to indicate a method for producing said cell contacting arrangement.

This object is achieved by the respective feature combinations of the independent claims. Each of the dependent claims shows advantageous configurations of the invention.

Hence, the object is achieved by a cell contacting arrangement for an energy storage module. These energy storage modules usually comprise a plurality of electrochemical storage cells, each of the storage cells having at least two electric connection terminals. According to the invention the cell contacting arrangement comprises a carrier plate which is mountable on the energy storage module, and a plurality of cell connectors which are inserted or integrated into the carrier plate for electrically contacting connection terminals. An individual one of said cell connectors contacts at least one connection terminal. Preferably, the cell connectors connect at least two connection terminals of two different storage cells. Alternatively, however, more than two connection terminals may be connected to a cell connector. The cell connectors are here arranged in the carrier plate such that they interconnect the connection terminals in series or in parallel. Furthermore, the cell contacting arrangement according to the invention comprises at least one cable harness for contacting said cell connectors and a cable harness support for receiving the cable harness. Said cable harness support is not an integral part of the carrier plate, but is a separate component. Hence, according to the invention said cable harness support is pre-equipped with the cable harness. Thereupon, the pre-equipped cable harness support is mounted on the carrier plate. Preferably, the cable harness support is connected to the carrier plate. According to the invention the cable harness can thereby be assembled separately in advance. As a consequence, the complexity of the carrier plate and the complexity of the tool for producing the carrier plate are reduced. When defective carrier plates are produced, the cable harness and the cable harness support are no longer affected, but the defectively produced carrier plate has just to be exchanged. Moreover, the carrier plate can also be configured in several parts without any problems.

In an advantageous configuration, a locking connection is provided between the carrier plate and the cable harness support. The cable harness support with the integrated cable harness can be very easily mounted in the carrier plate owing to this locking connection. Specifically, this locking connection comprises at least one detent on the cable harness support or on the carrier plate and a corresponding counterpart for the detent on the respective other component.

Moreover, it is preferably provided that the cable harness support is manufactured as an independent injection-molded part, separately from the carrier plate. Preferably, the carrier plate is also manufactured as an injection-molded part. The two components, cable harness support and carrier plate, are preferably made of plastics.

Furthermore, it is preferably provided that the cable harness support comprises at least one channel for receiving the cable harness. The cable harness used according to the invention may also consist of plural cable harness elements. For instance, the cable harness support can preferably comprise a plurality of said channels, with a bundle of individual wires of the cable harness then extending in a respective channel. At the end of said channels the wires are preferably combined to form a plug connector or a plug contact. In a preferred variant, the cable harness support comprises a plurality of branches. Said branches lead away from the channels of the cable harness support. Individual cable ends of wires of the cable harness are located in said branches. The cable ends are pre-positioned at specific positions via said branches. Particularly preferably, said cable ends of the individual wires project beyond the cable harness support. The cable ends can thereby be placed on the cell connectors to be contacted and can directly be connected, particularly welded or soldered, to the cell connectors.

The invention further comprises a high-voltage battery for power supply, particularly of an automotive vehicle. Said high-voltage battery comprises at least one energy storage module having a plurality of electrochemical storage cells, each storage cell comprising at least two electrical connection terminals. Furthermore, said high-voltage battery comprises at least one cell contacting arrangement, as has just been described. The advantageous configurations described within the framework of the cell contacting arrangement according to the invention are advantageously used on the high-voltage battery according to the invention in a corresponding way.

It is particularly provided that the storage cells are prismatic cells which, stacked into at least one row, are arranged one after the other and clamped between two end plates via tie rods.

Particularly preferably, all storage cells of an energy storage module are connected to one another electrically in series and/or in parallel by means of a joint cell contacting arrangement. The carrier plate is here made so large that it covers the whole surface of the energy storage module. The individual storage cells are arranged in the energy storage module such that all connection terminals are placed on one side of the energy storage module.

Furthermore, the present invention comprises a method for producing a cell contacting arrangement for an energy storage module. Said energy storage module has a plurality of electrochemical storage cells, each of the storage cells having at least two electric connection terminals. The method further comprises the following steps in a given sequence: providing a cable harness support, inserting a cable harness into the cable harness support, providing a carrier plate which is mountable on the energy storage module, with a plurality of cell connectors inserted or integrated into the carrier plate for contacting and/or electrically connecting connection terminals, mounting the cable harness support on the carrier plate and connecting cable ends of individual wires of the cable harness to the cell connector. The cable ends are preferably connected to the cell connectors by way of welding or soldering.

The advantageous configurations which have been discussed within the framework of the cell contacting arrangement according to the invention or the high-voltage battery according to the invention are advantageously used in the method according to the invention in a corresponding manner.

An embodiment of the invention shall now be explained in more detail with reference to the accompanying drawing, in which:

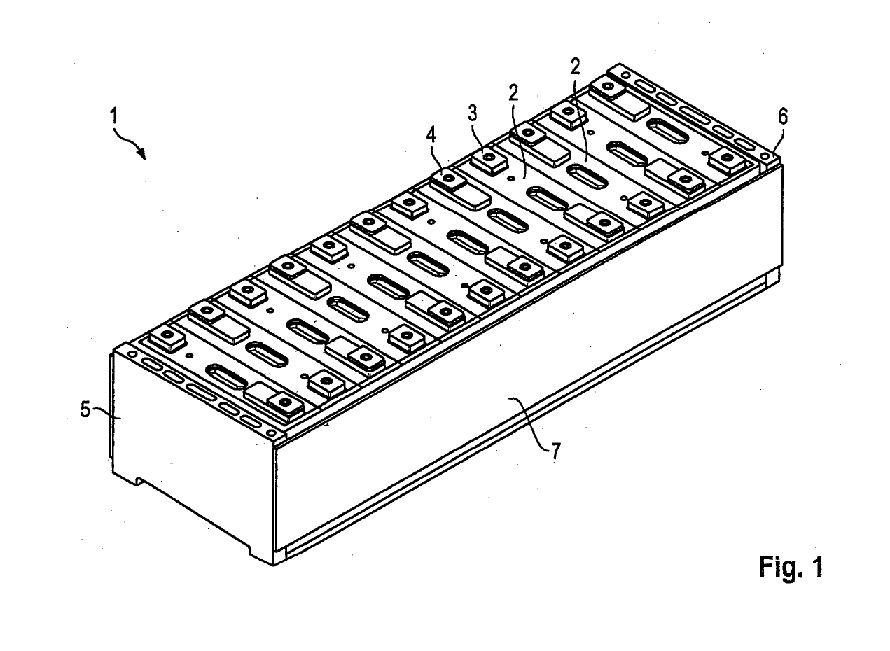

FIG. 1 shows an energy storage module on which a cell contacting arrangement according to the invention is mountable;

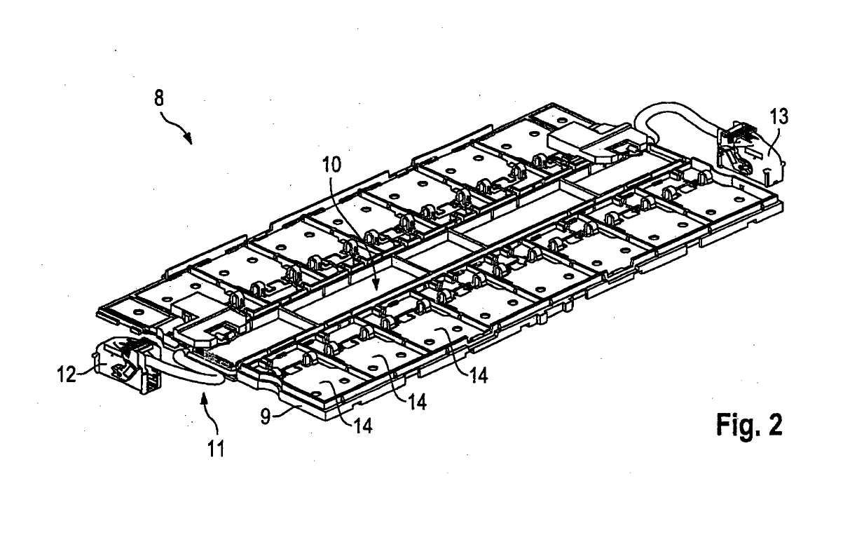

FIG. 2 shows a cell contacting arrangement of the invention according to the embodiment; and

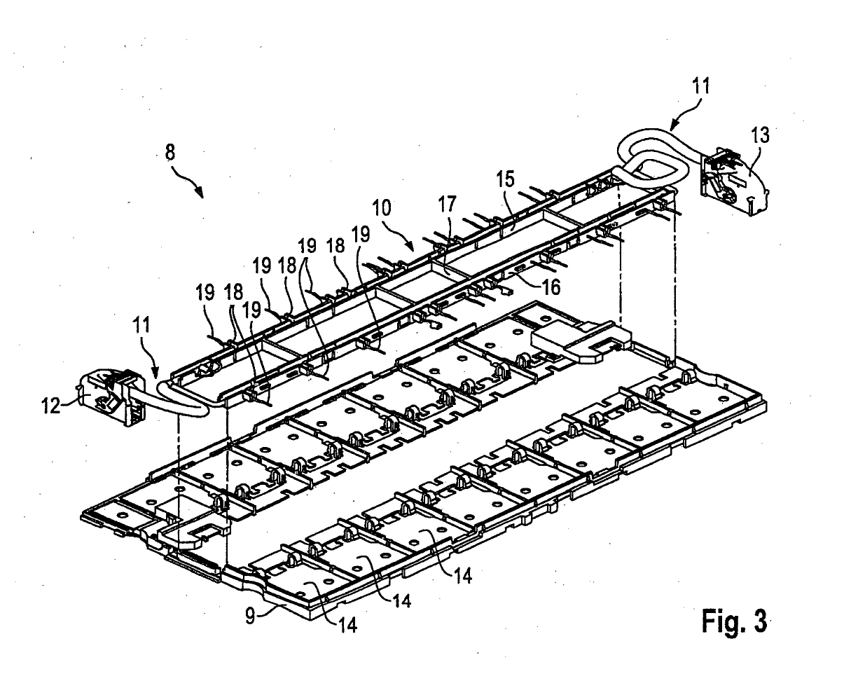

FIG. 3 is an exploded view of the cell contacting arrangement of the invention according to the embodiment.

An embodiment of a cell contacting arrangement 8 according to the invention shall now be explained in more detail with reference to FIGS. 1 to 3.

FIG. 1 is an illustration of an energy storage module 1—still without the mounted cell contacting arrangement 8. According to FIG. 1 the energy storage module 1 comprises a plurality of prismatic storage cells 2 which are stacked one after the other to form a row. Each of the storage cells 2 comprises a connection terminal of a first polarity 3 and a connection terminal of a second polarity 4. At least one electrochemical cell is respectively located in the interior of the storage cells 2.

The individual storage cells 2 of the energy storage module 1 are interconnected via end plates 5, 6. To this end a first end plate 5 is positioned at an end of the stacked row and a second end plate 6 is positioned at the opposite side. The two end plates 5, 6 are connected to each other and clamped via two tie rods 7 (FIG. 1 just shows one tie rod 7; a corresponding further tie rod is positioned at the opposite side).

All connection terminals 3, 4 of all storage cells 2 are oriented toward one side of the energy storage module 1, here: the top side. The cell contacting arrangement 8 according to the invention is mounted on said top side for contacting the individual storage cells 2.

FIGS. 2 and 3 show the detailed structure of said cell contacting arrangement 8. FIG. 2 shows the complete cell contacting arrangement 8 in the finished state. FIG. 3 shows an exploded view of the cell contacting arrangement 8.

The cell contacting arrangement 8 comprises a carrier plate 9 and a cable harness support 10. The carrier plate 9 is configured as an injection-molded part of plastics. For contacting individual connection terminals 3, 4, cell connectors 14 or receptacles for cell connectors are located in the carrier plate 9. Said cell connectors 14 consist of metal and contact at least one connection terminal 3, 4. Preferably, the cell connectors 14 respectively connect at least two connection terminals 3, 4 of at least two different storage cells 2. Alternatively, a cell connector 14 may also interconnect more than two connection terminals 3, 4. The cell connectors 14 connect the connection terminals 3, 4 either in series or in parallel with each other.

The cable harness support 10 comprises two parallel channels 15, 16 for receiving a cable harness 11. The two channels 15, 16 are interconnected via a plurality of webs 17. Branches 18 are formed on the channels 15, 16. The cable harness 11 comprises two cable strands. The one cable strand extends from the first channel 15 and ends with a first connector plug 12. A second strand of the cable harness 11 leaves the cable harness support 10 at the opposite side and ends with a second connector plug 13. Within the channels 15, 16 of the cable harness support 10 the cable harness 11 branches off to the individual branches 18. At the branches 18, cable ends 19 of individual wires of the cable harness 11 project beyond the cable harness support 10. Specifically, said protruding cable ends 19 are not insulated and may be connected by means of a welded or soldered connection to the cell connectors.

The exact positioning or arrangement of the channels 15, 16 and of the branches 18 allows an accurate positioning of said cable ends 19. The preassembled cable harness support 10, including the cable harness 11, is mounted on the carrier plate 9. The cable ends 19 are thereby placed on the cell connectors 14 and can be welded or soldered.

Hence, according to the invention, a modular structure is indicated for a cell contacting arrangement 8. The cable harness support 10 can be equipped and manufactured independently of the carrier plate 9.

### LIST OF REFERENCE NUMERALS

1 Energy storage device
2 Storage cell
3 Connection terminal of first polarity
4 Connection terminal of second polarity
5 First end plate
6 Second end plate
7 Tie rod
8 Cell contacting arrangement
9 Carrier plate
10 Cable harness support
11 Cable harness
12, 13 Connector plug
14 Cell connectors/cell connector receptacles
15 First channel
16 Second channel
17 Web
18 Branches
19 Cable ends

1. A cell contacting arrangement for an energy storage module having a plurality of electrochemical storage cells, each storage cell having at least two electric connection terminals, the arrangement comprising:
a carrier plate which is mountable on the energy storage module,
a plurality of cell connectors which are inserted or integrated into the carrier plate for contacting the connection terminals,
a cable harness for contacting the cell connectors, and
a separate cable harness support which is connectable to the carrier plate for receiving the cable harness.

2. The cell contacting arrangement according to claim 1, wherein a locking connection between the carrier plate and the cable harness support.

3. The cell contacting arrangement according to claim 1, wherein the cable harness support is manufactured as an independent injection-molded part, separately from the carrier plate.

4. The cell contacting arrangement according to claim 1, characterized in that wherein the cable harness support comprises at least one channel for receiving the cable harness.

5. The cell contacting arrangement according to claim 1, wherein cable ends of individual wires of the cable harness project beyond the cable harness support.

6. The cell contacting arrangement according to claim 1, wherein the cable harness support comprises a plurality of branches for positioning cable ends of individual wires of the cable harness.

7. A high-voltage battery for power supply, particularly of an automotive vehicle, comprising:
an energy storage module having a plurality of electrochemical storage cells, each storage cell having at least two electric connection terminals, and
a cell contacting arrangement according to any one of the preceding claims.

8. The high-voltage battery according to claim 7, wherein the storage cells are prismatic storage cells which, stacked into at least one row, are arranged one after the other and clamped between two end plates via tie rods.

9. The high-voltage battery according to claim 7, wherein all storage cells of the energy storage module are electrically interconnected in series and/or in parallel by means of a joint cell contacting arrangement.

10. A method for producing a cell contacting arrangement for an energy storage module having a plurality of electrochemical storage cells, each storage cell having at least two electric connection terminals, the method comprising the following steps in a given sequence:
providing a cable harness support,
inserting a cable harness into the cable harness support,
providing a carrier plate which is mountable on the energy storage module, with a plurality of cell connectors inserted or integrated into the carrier plate for contacting the connection terminals,
inserting the cable harness support into the carrier plate, and
connecting cable ends of individual wires of the cable harness to the cell connectors.
